(19) United States
(12) Patent Application Publication
(10) Pub. No.: US 2020/0316635 A1
(43) Pub. Date: Oct. 8, 2020

(54) SYSTEM AND METHOD FOR HANDLING AND PAINTING DOORS

(71) Applicant: Jeremy Stanley Ashe, Edmonton (CA)

(72) Inventor: Jeremy Stanley Ashe, Edmonton (CA)

(21) Appl. No.: 16/375,672

(22) Filed: Apr. 4, 2019

(51) Int. Cl. B05B 16/00; B05B 16/20

(52) U.S. Cl. CPC B05B 16/90; B05B 16/20

(57) ABSTRACT

A system is provided for utilizing a track for moving doors into position to be coated and subsequently removing the doors once coated.

### BACKGROUND OF THE INVENTION

As any skilled artisan can attest, the process of painting a plurality of doors is often an arduous one. The handling of doors before and after they are painted is typically a cumbersome and difficult task.

The present invention addresses this difficulty by providing a novel system and method for handling and painting doors.

### SUMMARY OF THE INVENTION

In one embodiment, the present invention is a system for painting doors, said system comprising:

an cubical enclosure having a first end and a second end, a track configured with brackets for holding individual doors;

at least one spray nozzle on an interior near said first end for applying paint or coating to a door;

whereby said track is constructed and arranged to move an individual door into a spray position near said spray nozzle and subsequently move a spray door away from said spray nozzle once a coding process is complete.

In one embodiment, the system is configured to move and paint doors utilizing a truck with a built in painting booth and a cart for transporting and storing doors. The truck has a painting and drying area that includes a track to slide or automatically take doors thru or into a drying area. Built in fans, heaters for drying doors with high quality finish in a controlled environment (no dust or chipping). Truck has hood vent for controlling paint overspray.

1. System can hold 10 or more doors, keeps doors from touching so no paint stick

2. Transport cart tilts for transporting thru doorways and stairs

3. Clean space to paint, hang and dry doors

In one embodiment, the truck supplies controlled environment for painting and drying (better quality). Also contemplated is a cart that transports doors to and from truck to protect doors. Doors go in with no paint and come out fully painted and dry ready to be transported on cart back to be hung in place.

There is no place on site for doors to be stripped, painted and stored until installed. They always get hit, chipped or marked before being installed and contaminants are always a problem with quality of the paint job. This system stores, transports, and holds door while they are transported to and from the quality controlled mobile paint booth. The present invention is novel in that it saves time, money and hassles that come with painting doors.

In one embodiment, the invention system for painting doors, said system comprising:

an cubical enclosure having a first end and a second end, a track configured with brackets for holding individual doors;

at least one spray nozzle on an interior near said first end for applying paint or coating to a door;

whereby said track is constructed and arranged to move an individual door into a spray position near said spray nozzle and subsequently move a spray door away from said spray nozzle once a coding process is complete.

In one embodiment, the invention is further including at least one fan positioned above a door in spray position.

In one embodiment, the invention is including at least one fan positioned near said second end.

In one embodiment, the invention is including a transport cart for moving doors into and out of said system.

### BREIF DESCRIPTION OF THE SEVERAL VIEWS OF THE DRAWINGS

FIG. 1 is a perspective view of the system according to one embodiment of the present invention.

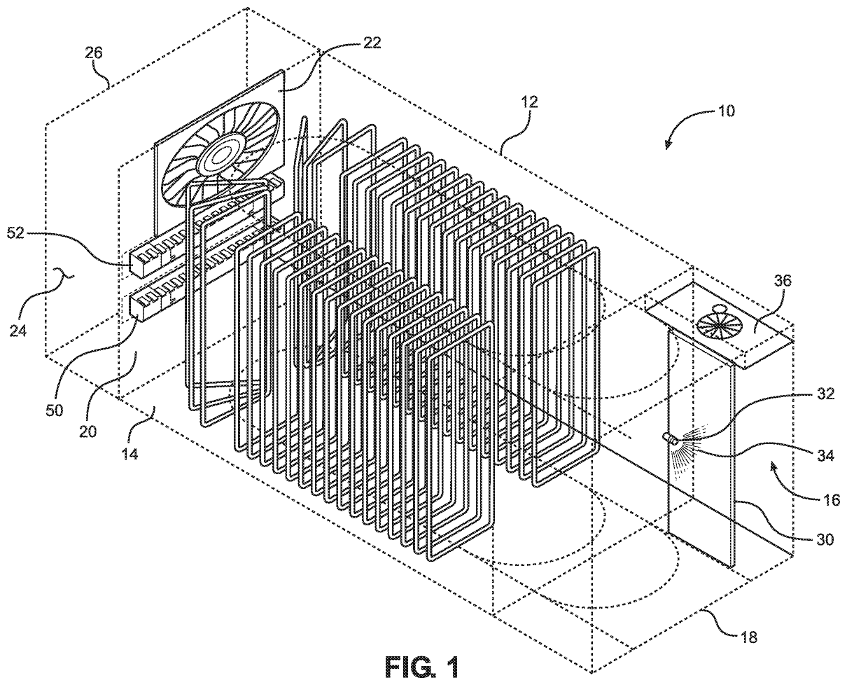

FIG. 2 is a top view of the system according to one embodiment of the present invention.

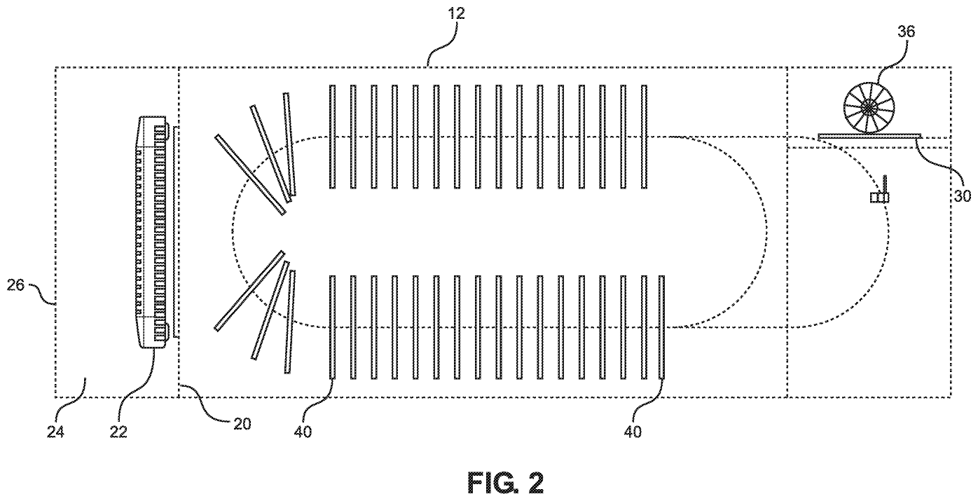

FIG. 3 is a perspective view of a door handling and transportation apparatus according to one embodiment of the present invention.

FIG. 4 is a door storage and movement cart according one embodiment of the present invention.

FIG. 5 is a perspective of one movement embodiment according to the present invention.

### DETAILED DESCRIPTION OF THE PREFERRED EMBODIMENT

As used herein, the term paint and painting refers to any liquid or aqueous based solution applied to a door. Solutions include but are not limited to paint, stains, various functional and nonfunctional coatings, and combinations thereof.

In general, the present invention is a plurality of components that for the sake of description will be referred to collectively as a system.

System 10 includes an enclosure 12. Enclosure 12 has positioned therein a track with a plurality of doors 40. A single door 32 be referred to as the working door is moved into position by movable spray nozzle 32. Spray nozzle 32 applies a spray 34 of a paint or other coating. Spray fan 36 is positioned above spray door 30. Spray fan 36 assists in the drying process once door 30 is sprayed with coding 34. The system is constructed and arranged such that one or more of spray nozzles 30 are incorporated. Additionally, door 30 is sprayed on a selected side, or both sides as desired. system 10 further includes fan 22 mounted on fan support wall 20. System 10 further includes heater 50 and optionally heater 52. Fan wall 20 is offset from fan and 26 of system 10. System 10 is further constructed with a cavity 24 positioned between fan support wall 20 and fan and wall 26 of system 10.

As used herein, door 40, refers to any door handled according to the present invention that is not in a position for spraying.

As used herein, door 30 refers to a specific individual door moved into position in front of one or more spray nozzles 32.

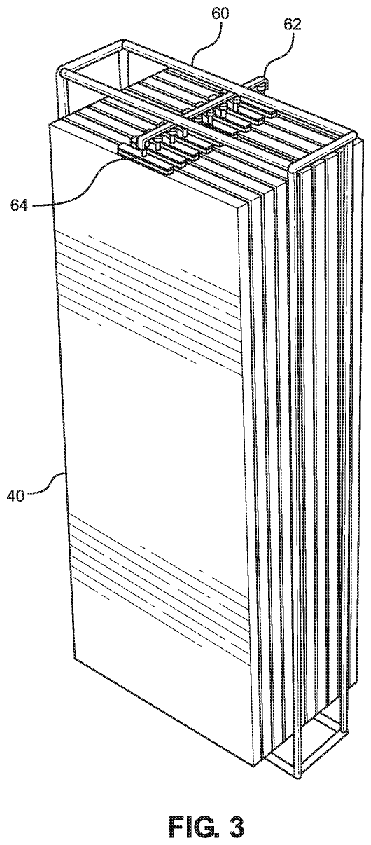

The present invention further contemplates, as demonstrated in FIG. 3, a system for transporting doors whereby cart 60 is formed with bracket support 62 that holds individualized door brackets 64. Each individualized or bracket 64 holds a single door 40.

In use, a plurality of doors 40 are positioned inside enclosure 12. An individual door 30 is moved into position, the door is sprayed with a spray 34 emanating from one or more nozzles 32. As stated above, users can select to spray one side or both sides of door 30. Door 30 is then moved back into position with doors 40 and a subsequent door is then sprayed.

In one embodiment, one or more doors are moved on door movement frame 60 in which bracket support 62 supports one or more upper door brackets 64 each holding a single door 40.

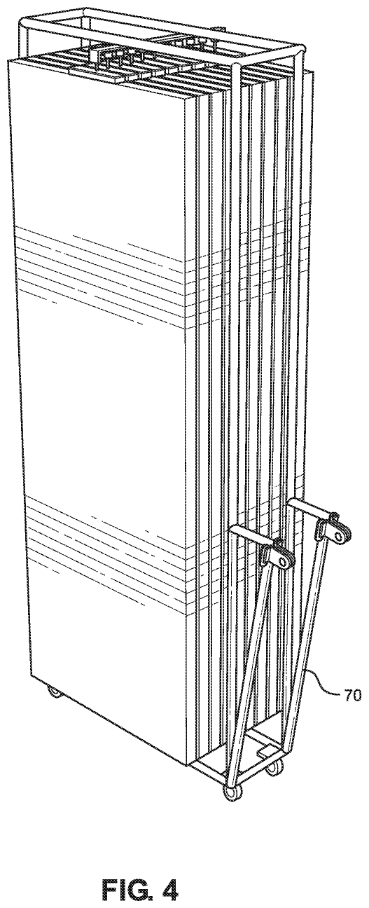

In one embodiment, as in FIG. 4, frame 60 is formed with wheeled cart 70 for transporting doors to and from system 10.

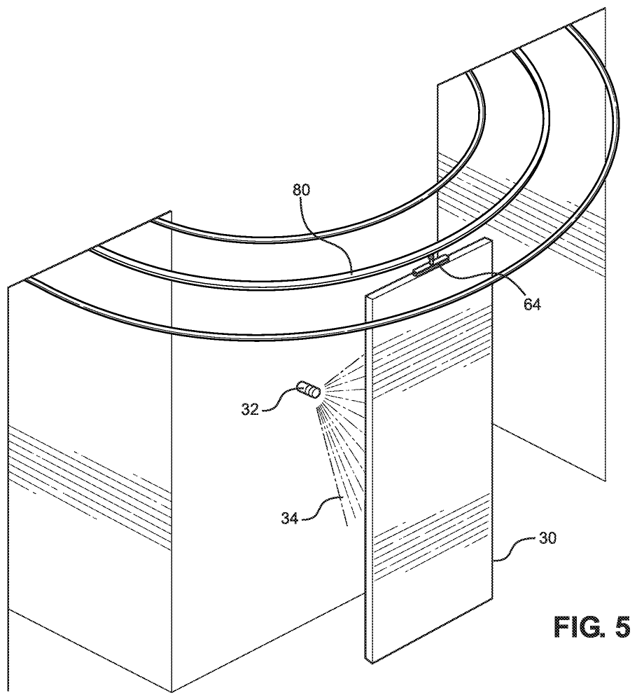

FIG. 5 is demonstrative of a transport system whereby a single door to be sprayed 30 is moved by transport rack 80 in front of spray nozzle 32 for coating 34 to be applied. Spray nozzle can be any one or more of a manually operated spray nozzle, a fully manual hand held spray nozzle system, a semi automatic spray system or a fully automatic system.

Bracket support 62 is constructed and arranged to pivot about a central axis allowing door 30 to rotate 360 degrees to facilitate coating one or both sides as desired. The specific location of the spray system is selectable. However, wherever spray system is position, it is contemplated as being near and under fan 30 for drying an applied coating.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for painting doors, said system comprising:
an cubical enclosure having a first end and a second end, a track configured with brackets for holding individual doors;
at least one spray nozzle on an interior near said first end for applying paint or coating to a door;
whereby said track is constructed and arranged to move an individual door into a spray position near said spray nozzle and subsequently move a spray door away from said spray nozzle once a coding process is complete.

2. The system of claim 1 further including at least one fan positioned above a door in spray position.

3. The system of claim 1 further including at least one fan positioned near said second end.

4. The system of claim 1 including a transport cart for moving doors into and out of said system.
